(19) United States
(12) Patent Application Publication
(10) Pub. No.: US 2006/0082237 A1
(43) Pub. Date: Apr. 20, 2006

(54) Toroidal AC motor

(75) Inventor: Jack H. Kerlin, Provo, UT (US)

Correspondence Address: JONES DAY, 2882 SAND HILL ROAD, SUITE 240, MENLO PARK, CA, 94025, US

(73) Assignee: Raser Technologies, Inc., Provo, UT (US)

(21) Appl. No.: 10/970,709

(22) Filed: Oct. 20, 2004

(51) Int. Cl. H02K 19/00; H02K 17/00; H02K 1/22

(52) U.S. Cl. 310/166; 310/164; 310/265; 310/156.02

(57) ABSTRACT

A toroidal motor having a generally circular rotor surrounded by an annular stator is disclosed. The rotor has a plurality of poles disposed about a circumference thereof. A shaft extends axially away from the poles and is attached to the rotor. The stator is generally annular and includes an annular winding surrounding the circumference thereof. Disposed about the winding are a plurality of stator poles. The number of stator poles is generally equal to the number of rotor poles. When the winding and hence the stator is excited, a magnetic field is produced between the stator and rotor poles that creates torque upon the shaft.

### BACKGROUND OF THE INVENTION

1. Field of the Invention

The present invention generally relates to electrical motors and more particularly to an electric motor having a toroidal magnetic flux configuration to increase torque production.

2. Description of the Related Art

Most typical electric motors or generators can be considered alternating current (AC) devices requiring alternating current at the basic operational level. For example, traditional direct current (DC) motors utilize mechanical switching mechanisms such as commutators and brushes to convert DC input current into AC current that operates the motor. A brushless DC motor is analogous to the traditional brush-type DC machine wherein the mechanical commutator has been replace by an electronic solid-state switching controller to create AC power from a DC source. The brushless DC motor typically has a 3-phase stator with a permanent magnet rotor such that it resembles an AC synchronous motor with an electrically excited rotor.

The AC synchronous motor format illustrates an ideal motor format because both the rotor and stator magnetic fields are produced electromagnetically without permanent magnet materials and torque angle can be controlled at an optimum 90° for peak efficiency. However, the two main drawbacks preventing widespread commercialization of the AC synchronous motor are that there must be zero starting torque at a fixed input frequency and that the motor must utilize slip rings and brushes for rotor excitation.

The above-described motor types, along with other numerous derivatives, typically have a radial flux configuration wherein the magnetic field is radially directed through an air gap separating the cylindrically shaped rotor and stator.

There are two theoretical methods for increasing motor torque in any conceivable motor design. Namely, the torque can be increased by increasing the total stored magnetic energy E_{M} or increasing the number of poles N_{P} of the motor, as more fully explained in Applicants co-pending patent application entitled “AC INDUCTION MOTOR HAVING MULTIPLE POLES AND INCREASED STATOR/ROTOR GAP, Ser. No. 10/894,688, filed Jul. 19, 2004, the contents of which are incorporated by reference herein. However, both of the methods decrease the efficiency of the motor. Resistive losses in the motor increase as the square of the pole-number and the square of the length of the gap (l_{g}) between the stator and rotor while torque is only directly proportional to the pole-number and the gap length l_{g}. As such, efficiency drops off as poles increase and as stored magnetic energy increases because resistive losses quickly outstrip torque gain achieved by increasing these two variables.

The motor described below addresses these deficiencies by providing a high number of poles and consequent high torque without incurring unacceptable thermal losses. Furthermore, the design of the motor permits a longer gap length l_{g} to thereby provide expanded storage of magnetic energy E_{M}.

### SUMMARY OF THE INVENTION

The design of the toroidal AC motor permits a high pole number N_{P} and consequent high torque without incurring unacceptable thermal losses. The copper cross-sectional area A_{C} of the winding is increased to permit a longer gap length l_{g} and thus expanded storage of magnetic energy E_{M}. In this regard, the toroidal motor has a stator with a plurality of U-shaped stator poles and a winding disposed within the “U” of each of the poles. The winding is generally annular with the poles being placed around the outer circumference thereof. The motor further includes a rotor having a plurality of rectangular shaped poles disposed in a generally circular configuration. Each of the rotor poles corresponds to one of the stator poles. The stator is configured as a ring which surrounds the rotor and the rotor poles. The rotor is held in position by end-rings and bearings such that the rotor can rotate within the stator. The rotor further includes a shaft extending axially therefrom which turns in response to exciting the stator with the winding.

### BRIEF DESCRIPTION OF THE DRAWING FIGURES

These as well as other features of the present invention will become more apparent upon reference to the drawings wherein:

FIG. 1 is a perspective view of a toroidal motor;

FIG. 2 is a cross-sectional view of the motor shown in FIG. 1;

FIG. 3 is an exploded perspective view of the motor shown in FIG. 1;

FIG. 4 is an exploded perspective view of the stator and rotor for the motor shown in FIG. 1;

FIG. 5 is a perspective view of the rotor-stator assembly without end-rings for the motor shown in FIG. 1;

FIG. 6 is a perspective view of the stator with end-rings for the motor shown in FIG. 1;

FIG. 7 is a perspective view of the stator shown in FIG. 6 without end-rings;

FIG. 8 is a perspective view of the rotor with end-rings for the motor shown in FIG. 1;

FIG. 9 is a cross-sectional view of the rotor-stator pole layout for the motor shown in FIG. 1;

FIG. 10 illustrates the stator and rotor for a second embodiment of the motor constructed in accordance with the present invention;

FIG. 11 is an exploded view of the stator and rotor shown in FIG. 10;

FIG. 12 perspectively illustrates the stator shown in FIG. 10;

FIG. 13 perspectively illustrates the rotor shown in FIG. 10;

FIG. 14 illustrates the rotor-stator pole orientation for the motor shown in FIG. 10;

FIG. 15 is cross-sectional view of the stator shown in FIG. 10; and

FIG. 16 is a cross-sectional view of the motor shown in FIG. 10.

### DETAILED DESCRIPTION OF THE INVENTION

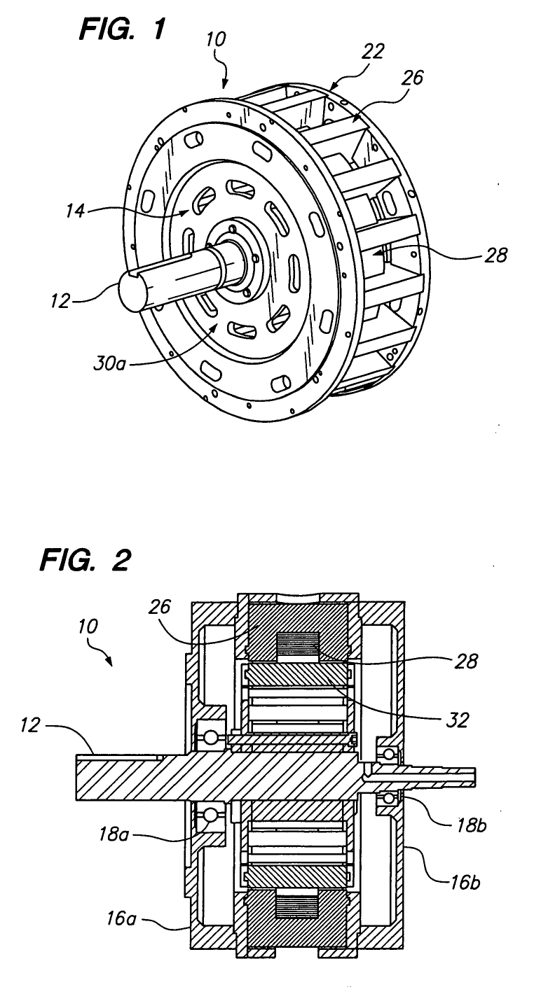

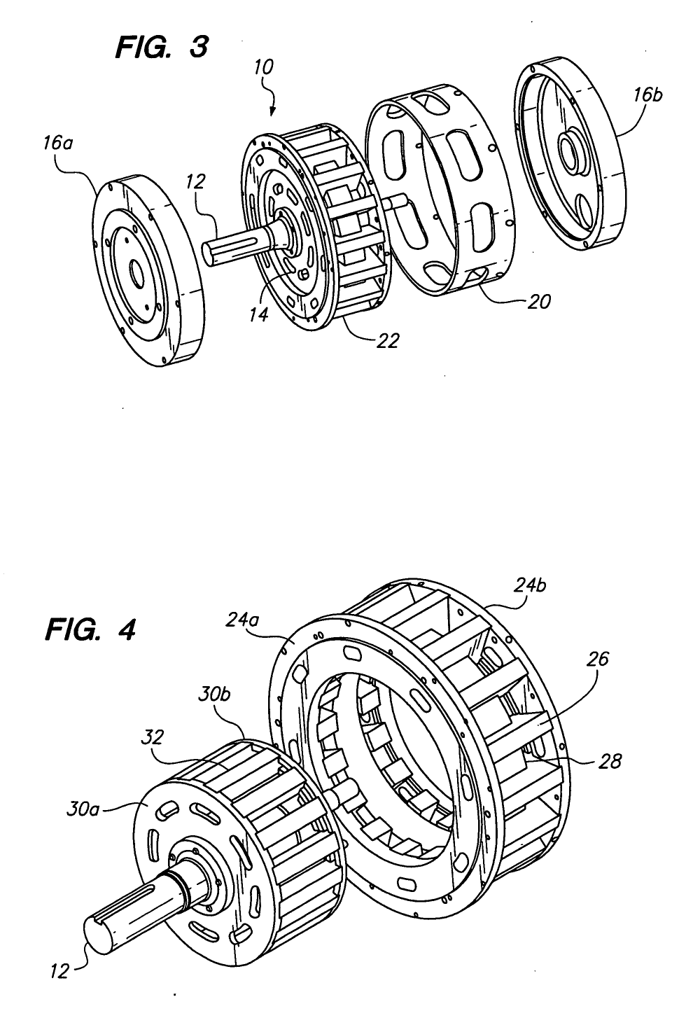

Referring now to the drawings wherein the showings are for purposes of illustrating preferred embodiments of the present invention only, and not for purposes of limiting the same, FIG. 1 is a perspective view of a first embodiment of a toroidal motor 10 whereby the magnetic lines of flux generally follow a toroidal pattern. As used herein the term toroidal refers to a donut or torus shape. Referring to FIGS. 1-3, the motor 10 has a shaft 12 attached to and extending generally perpendicular from a rotor 14. The shaft 12 is supported within first and second end-bell housings 16a, 16b by respective bearings 18a, 18b. A motor housing 20 is disposed between the first and second end-bells 16a, 16b. As seen in FIG. 3, the motor also has a stator 22 which circumferentially surrounds the rotor 14.

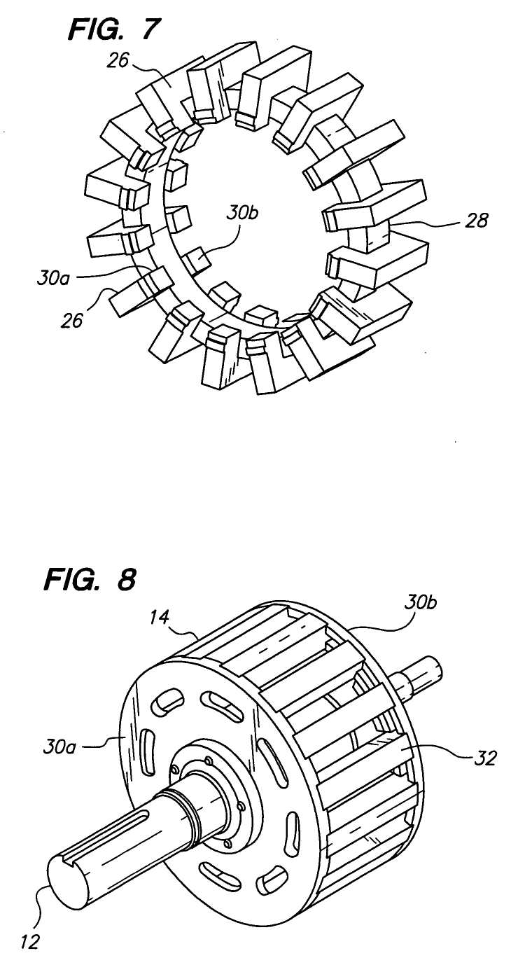

Referring to FIGS. 1, 6 and 7, the stator 22 has two end-rings 24a and 24b that support a plurality of stator poles 26. The stator poles 26 are circumferentially disposed around the end-rings 24a, 24b. Each of the stator poles 26 are formed from a generally U-shaped metallic material such as stacks of iron laminations. In high frequency applications, the stator poles 26 would be formed from a solid ferrite material. The U-shaped stator poles envelope a conductive stator winding 28 such that the stator poles 26 surround the stator winding 28 on three sides. The stator winding 28 is a generally circular loop coil nested within the laminations of the stator poles 26. Each one of the stator poles 26 has two stator faces 30a, 30b facing the inside of the stator 22 and hence the rotor 14. The stator poles 26 are actively excited by the stator winding 28.

Referring to FIG. 8, the rotor 14 is shown as comprising a first and second end-ring 30a, 30b attached to the shaft 12. The end-rings 30a, 30b support a plurality of rotor poles 32 disposed circumferentially thereabout. Each of the rotor poles 32 is a generally rectangular shaped ferromagnetic material or stacks of iron laminations. Only the stator poles 26 are actively excited by the winding 28, while the rotor poles 32 are passively excited from the magnetic field created by the stator 22.

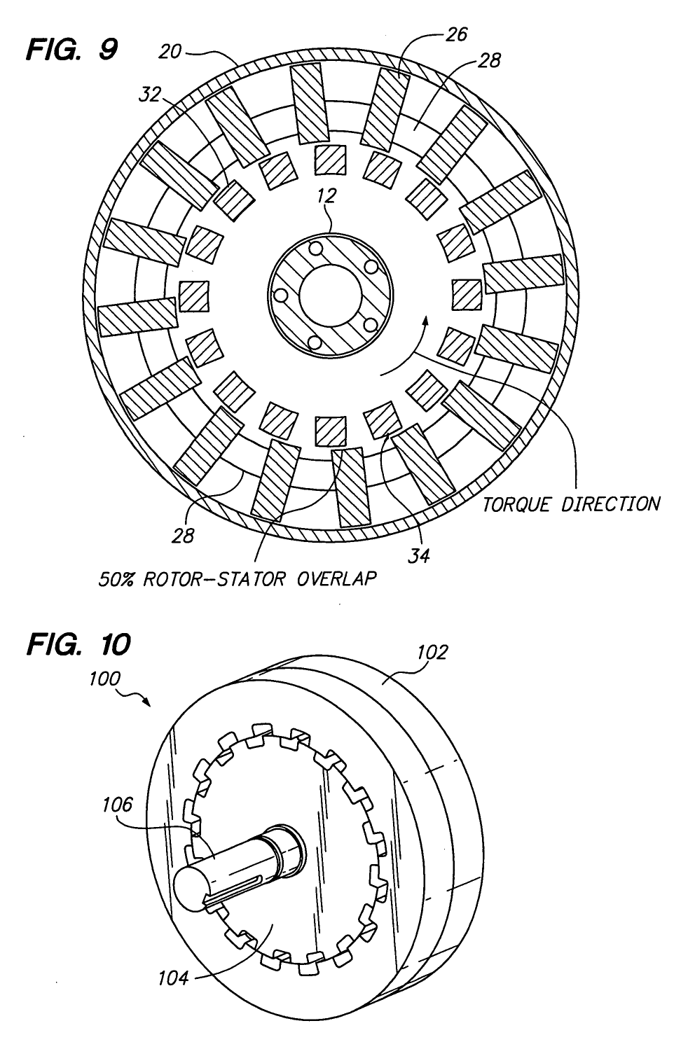

Referring to FIG. 9, a cross-sectional view showing the relationship between the stator poles 26 and the rotor poles 32 is shown. A rotor-stator pole gap 34 is formed between the rotor poles 32 and the stator poles 26 when the rotor 14 is inserted within the stator 22. The position of the stator poles 26 overlap the rotor poles 32 by 50% for illustrative purposes only in FIG. 9. During operation, the rotor 14 rotates within the stator 22 as will be further explained below. When the stator winding 28 is excited, a counter-clockwise torque is developed on the shaft 12. As seen in FIG. 9, the number of rotor poles 32 is equal to the number of stator poles 26.

The motor 10 with the toroidal format can be considered a variable reluctance machine. The single loop coil comprising the winding 28 does not permit combining phases on a common stator core following standard practice with conventional AC machines. As such, the stator and rotor poles 26, 32 are formed mechanically as salient poles rather than formed magnetically as in poly-phase smooth bore AC designs. Salient poles are naturally adapted to variable reluctance operating principles such that the motor 10 possesses the innate characteristics of a variable reluctance machine.

In the operation of the motor 10, the excitation of the winding 28 creates a magnetic field that flows through the U-shaped stator poles 26 and the bar-shaped rotor pole 32 thereby traversing the rotor-stator pole gap 34 twice. The circulation of the flux is similarly found in a horseshoe magnet (stator pole) and keeper bar (rotor pole). The magnetic lines of force trace out a generally concentric pattern surrounding the stator winding 28 on a plane perpendicular to the direction of current.

Torque is developed as the rotor and stator poles 26, 32 attempt to align into a position of minimum reluctance. As previously discussed, FIG. 9 shows a partial alignment at the halfway point of complete pole overlap. Tangential components of the ferromagnetic attractive forces constitute the torque-producing mechanism common to variable reluctance machines.

The excitation of the winding 28 ceases when alignment between the rotor and stator poles 26, 32 reaches full overlap. Then the rotor 14 coasts for half the overall torque cycle until it arrives at zero overlap. Then excitation of the winding 28 again commences for the next torque pulse such that torque is generated in pulses of a 50% duty cycle. The pulses can be generated and transferred to the winding 28 using commonly known techniques.

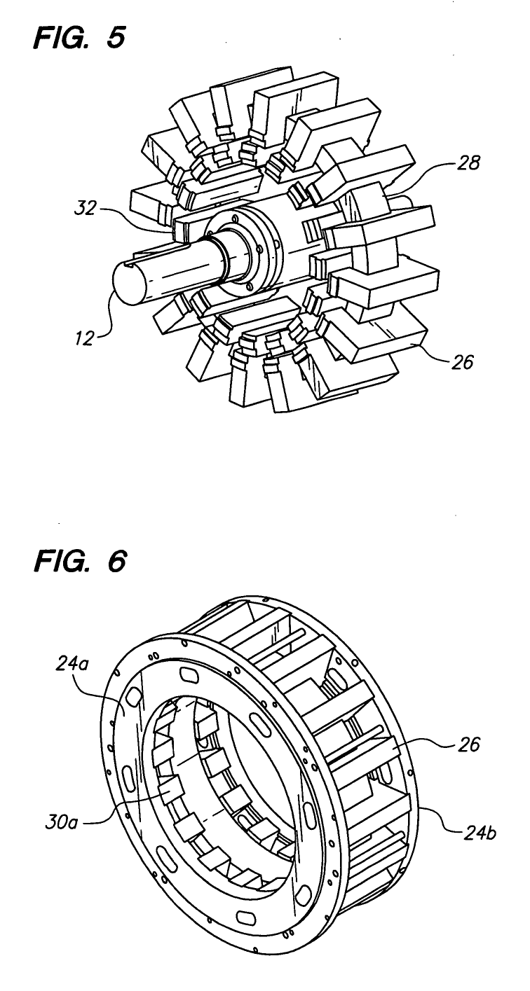

FIGS. 1-9 show half of one phase for an electric motor. It will be recognized that another half-phase pole structure that is displaced by 180 electrical degrees from the first half-phase pole structure creates torque during the coasting portion of the torque cycle of the first half-phase pole structure. Accordingly, the two half-phase pole structures comprise an entire single phase. A second complete phase (i.e., consisting of another two half-phase pole structures) enables full starting torque without dead spots that otherwise would appear in the torque cycle of a single phase.

Ideally, the stator winding 28 should be shorted out at the point of 50% overlap in order to allow conversion of co-energy to shaft energy by means of internally circulating stator current. This process occurs during the flux expansion stage in a motor, or flux compression stage in a generator, in order to allow full recovery of magnetic co-energy in the rotor-stator gap for peak operating efficiency. Running torque under the optimal scenario of total co-energy recovery is one-fourth of the static torque.

Referring to FIG. 10 a second embodiment of the toroidal motor 100 is shown. The motor 100 has a generally circular stator 102 and rotor 104. A shaft 106 extends perpendicularly (i.e., axially) from the rotor 104. The rotor 104 is sized and configured to rotate within the stator 102. For the embodiment shown in FIG. 10, the motor 100 has sixteen rotor poles and sixteen stator poles. Because all of the poles are driven by a single coil, the number of stator poles is equal to the number of rotor poles so that all of the poles act in unison creating torque simultaneously. The stator 102 and rotor 104 is one phase of a complete motor. Three phases are needed in order to produce the necessary amount of starting torque.

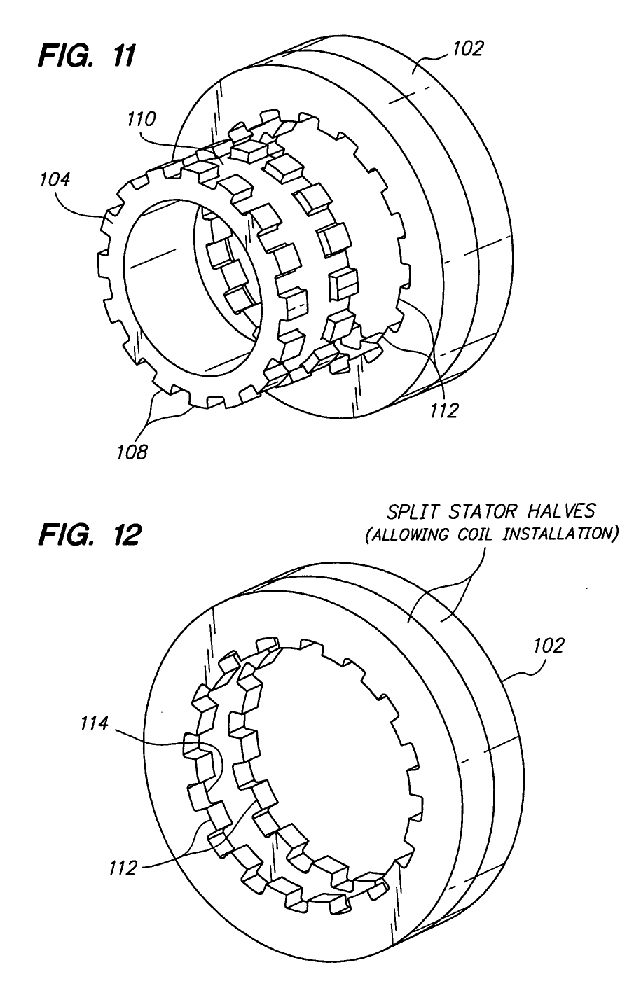

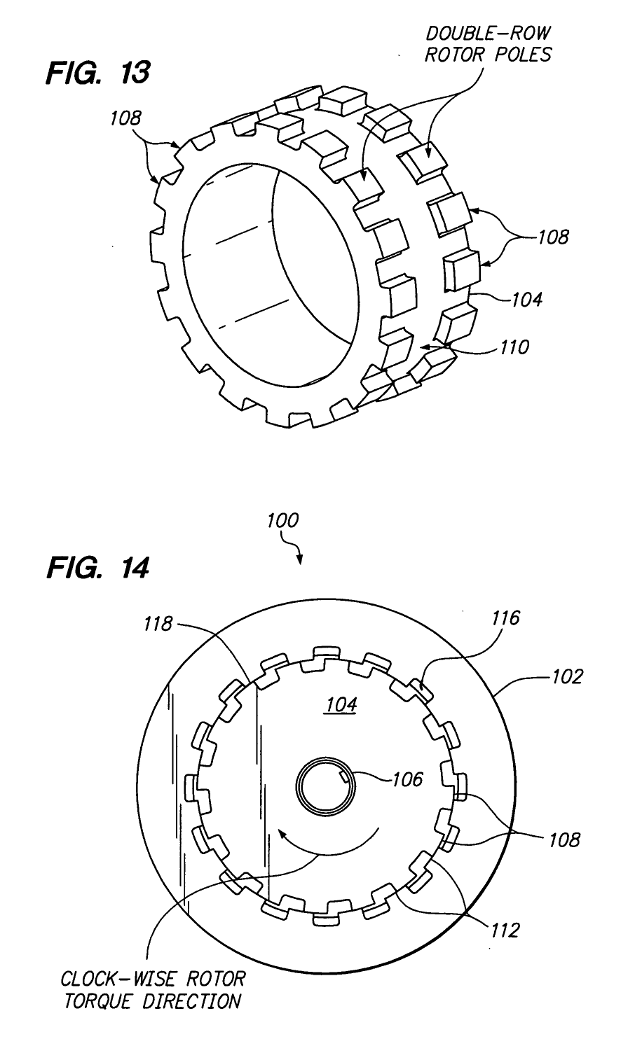

Referring to FIG. 11, an exploded view of the rotor 104 and stator 102 with the shaft 106 removed is shown. The rotor 104 has rotor poles 108 spaced circumferentially around the exterior thereof. The rotor poles 108 are placed on the outside edges of the rotor 104 such that a groove 110 is formed between the poles 108 as seen in FIG. 13. The two rows of rotor poles 108 are positioned in direct axial alignment with one another. As seen in FIG. 11, the rotor poles 108 are a series of teeth formed in the rotor 104.

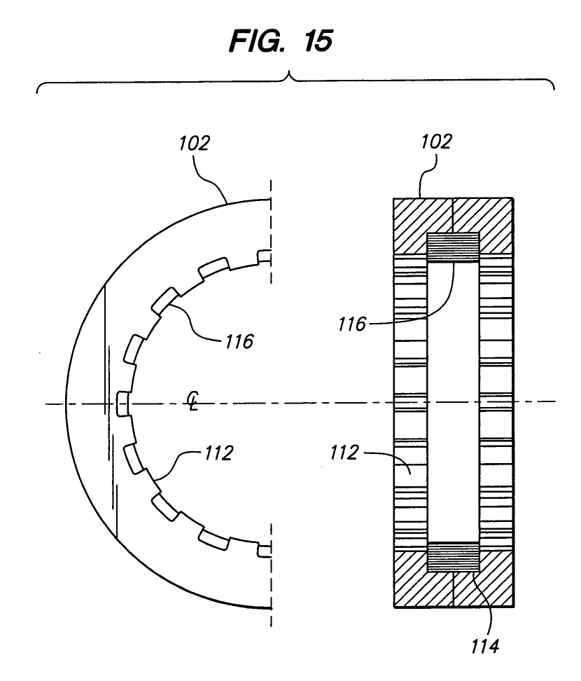

The stator 102 has a series of stator poles 112 formed around the inner circumference thereof. Referring to FIG. 12, the stator poles 112 are formed into a double row such that a stator coil cavity 114 is formed. The stator coil cavity 114 houses the stator coil (i.e., winding). As seen in FIG. 15, the stator coil 116 is essentially a circular hoop of multiple turns nested within the annular stator coil cavity 114. Coil installation is facilitated by splitting the stator 102 into two halves thereby allowing access to the stator coil cavity 114 during installation. The two rows of stator poles 112 are positioned in direct axial alignment with one another.

FIG. 14 illustrates the clockwise development of torque in the motor 100. The stator coil 116 can be seen visible between the stator poles 112. The rotor and stator poles 108, 112 overlap in a rotor-stator pole overlap region 118. The overlap region 118 creates a progressively increasing gap volume as the rotor 104 rotates clockwise. Accordingly, magnetic co-energy is accumulated within the gap between the rotor and stator poles 108, 112, during development of torque.

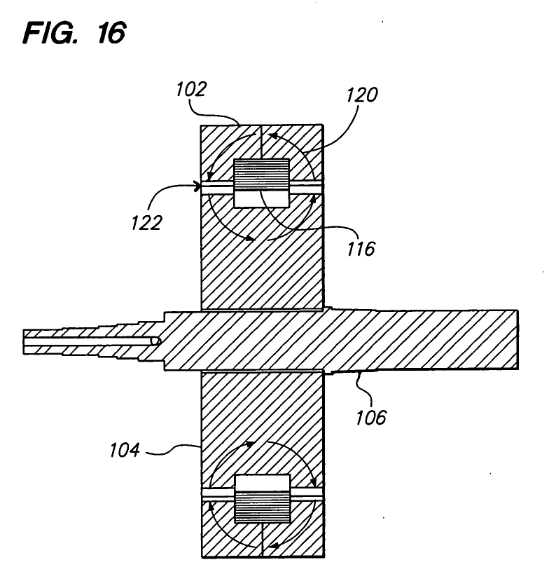

A cross-sectional view of the entire rotor-stator assembly for the motor 100 is shown in FIG. 16. A magnetic flux path 120 encircles the stator coil 116 to include both the rotor 104 and the stator 102 in a common magnetic circuit. The combination of the rotor 104 and the stator 102 provide the conduction medium for the magnetic field arising from excitation of the single stator coil 116. Interaction of the magnetic field at an interface 122 of the faces of the rotor-stator poles 108,112 creates rotor torque. Accordingly, the magnetic lines of force (i.e., magnetic flux path 120) trace out a toroidal pattern.

The net effect of the toroidal format is to maintain space between poles entirely free of copper winding. Any number of poles may thereby be added without restricting a copper cross sectional area A_{C}. The quantity of copper-per-phase remains constant irrespective of the pole number N_{P}. Current density is unaffected by the number of poles so that full flux density B_{g} is sustained across the gap as strictly a function of gap length l_{g} and independent of iron area A_{M}. Furthermore, the number of poles can be added without incurring dissipative losses because there is no relationship between heat generation to the pole number N_{P}. In fact increasing the number of poles raises the torque-to-heat ratio because more torque is produced by the motor without raising heat.

The toroidal format permits a large copper winding cross-sectional area A_{C} that results in a copper-to-iron ratio several times higher than found in standard machines. Whereas other machines concentrate a high proportion of overall machine weight in the iron core, the format of the motor 10 reverses the iron-copper weight proportions so that copper becomes the dominant constituent such that the motor 10 becomes a copper-based machine.

An enlarged copper cross-sectional area A_{C} for the format of the motor 10 permits a proportional increase in amp-turns (ni) without raising current density J that would otherwise create prohibitive heat loss. High amp-turns (ni), in turn, drives flux across a longer gap length l_{g} than traditionally employed. Therefore, total magnetic energy E_{M} stored in the gap is therefore amplified several times above standard practice such that torque production is enhanced.

The ratio of electrical frequency to shaft frequency (speed) is proportional to the number of poles. The ultimate limitation to torque density and efficiency is the frequency-dependent magnetic property of the core material. Eddy-current losses are proportional to the square of electrical frequency, while magnetic or hysteresis losses vary by the first-power of electrical frequency. These two frequency dependent loss mechanisms inherent in an iron machine core prevent motor operation above about 800 Hz. Higher electrical frequency requires the use of a non-ferrous core material such as ferrite that has very low eddy-current and hysteresis losses and is capable of operating at tens of kHz. The drawback with ferrite as a core material is that the saturation of flux density is about half of iron. In switching from iron to ferrite, the pole number should be increased to recover the limiting effects of ferrite's lower flux density.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative devices within the spirit and scope of the invention.

1. A synchronous AC toroidal motor comprising:
a generally circular rotor having a plurality of rotor poles disposed about a rotor circumference, and a shaft extending axially from the rotor, the plurality of rotor poles being made of a ferromagnetic material that does not have a permanent magnetic field;
a generally annular stator circumferentially surrounding the rotor, the stator having an annular winding and a plurality of stator poles disposed about the circumference of the winding, the stator sized and configured to surround the rotor and define a gap therebetween;
wherein excitation of the winding creates a magnetic field between the rotor poles and the stator poles to create torque on the rotor shaft.

2. The motor of claim 1 wherein:
each of the stator poles is generally U-shaped; and
each of the rotor poles is generally rectangular.

3. The motor of claim 2 wherein each of the stator poles is positioned on the winding such that the stator poles surrounds the winding.

4. The motor of claim 2 wherein each of the stator poles has two generally planar faces formed from the U-shaped configuration and the stator poles are positioned on the winding such that the planar faces are facing the rotor poles.

5. A method of making a synchronous AC toroidal motor, the method comprising the following step:
attaching a plurality of rotor poles circumferentially around a shaft to form a rotor, the rotor poles being made of a ferromagnetic material that does not have a permanent magnetic field;
attaching a plurality of stator poles around an annular winding to form a stator;
positioning the stator around the rotor such that excitation of the stator creates a magnetic field between the rotor poles and the stator poles to create torque on the shaft.

6. The method of claim 5 further comprising the step of attaching a plurality of generally rectangular shaped rotor poles around the shaft.

7. The method of claim 5 further comprising the step of attaching a plurality of generally U-shaped stator poles around the winding.

8. The method of claim 7 further comprising the step of attaching the stator poles to the winding by positioning each of the stator poles to substantially surround the winding.

9. A synchronous AC toroidal motor comprising:
a generally circular rotor having two rows of rotor poles disposed about an outer circumference of the rotor and a shaft extending axially from the rotor, the rotor poles being made of a ferromagnetic material that does not have a permanent magnetic field; and
a generally annular stator sized and configured to circumferentially surround the rotor, the stator having two rows of stator poles disposed about an inner circumference thereof such that a cavity is defined between the two rows, the stator further comprising a winding disposed within the cavity;
wherein excitation of the winding creates a magnetic field between the rotor poles and the stator poles to create torque on the rotor shaft.

10 The motor of claim 9 wherein each of the stator and rotor poles is generally rectangular.

11. The motor of claim 10 wherein the rows of stator poles are positioned in direct angular alignment with one another.

12. The motor of claim 10 wherein the rows of rotor poles are positioned in direct angular alignment with one another.

13. A synchronous AC toroidal motor, comprising:
a rotor having a single row of rotor poles disposed about an outer circumference of the rotor, and a shaft extending axially from the rotor, the rotor poles being made of a ferromagnetic material that does not have a permanent magnetic field;
a stator sized and configured to circumferentially surround the rotor, the stator having a first row of stator poles and a second row of stator poles disposed about an inner circumference thereof such that a cavity is defined between the first and second rows, the stator further including a winding disposed within the cavity;
each of the rotor poles being sized and configured to extend from a first position on the rotor adjacent to the first row of stator poles to a second position on the rotor adjacent to the second row of stator poles;
wherein excitation of the winding creates a magnetic field between the rotor poles and the stator poles to create torque on the rotor shaft.

14. The motor of claim 13, wherein the rows of stator poles are positioned in direct angular alignment with one another.

15. The motor of claim 13, wherein the rotor poles are made of a solid ferrite material.

16. The motor of claim 13, wherein the rotor poles are made of a plurality of layers of iron lamination.
